(19) United States
(12) Patent Application Publication
(10) Pub. No.: US 2024/0394041 A1
(43) Pub. Date: Nov. 28, 2024

(54) CENTER DEVICE, AND METHOD FOR GENERATING DISTRIBUTION PACKAGE

(71) Applicant: DENSO CORPORATION, Kariya-city (JP)

(72) Inventors: Masaaki ABE, Kariya-city (JP); Hideo YOSHIMI, Kariya-city (JP); Koto TOMATSU, Kariya-city (JP)

(21) Appl. No.: 18/795,045

(22) Filed: Aug. 5, 2024

Related U.S. Application Data
(63) Continuation of application No. PCT/JP2023/000986, filed on Jan. 16, 2023.

(30) Foreign Application Priority Data
Feb. 10, 2022 (JP) 2022-019598

(51) Int. Cl. G06F 8/65

(52) U.S. Cl. CPC G06F 8/65

(57) ABSTRACT

A center device manages data to be written to a plurality of electronic control devices installed in a vehicle. The center device is configured to generate a package including update data to be distributed to the vehicle; and distribute the package to the vehicle. When an input of information on a master device to which a package is to be distributed is received, the center device identifies an ID corresponding to the master device with reference to a logic ID management registration section on a basis of the information, acquires logic corresponding to the ID from a logic management registration section, and generates a package on a basis of the logic.

### CROSS REFERENCE TO RELATED APPLICATION

The present application is a continuation application of International Patent Application No. PCT/JP2023/000986 filed on Jan. 16, 2023 which designated the U. S. and claims the benefit of priority from Japanese Patent Application No. 2022-019598 filed on Feb. 10, 2022. The entire disclosures of all of the above applications are incorporated herein by reference.

### TECHNICAL FIELD

The present disclosure relates to a center device that manages data to be written to a plurality of electronic control devices installed in a vehicle, and a method for generating a distribution package.

### BACKGROUND

For example, a related art discloses a technique in which an ECU update program is distributed from a server to an in-vehicle device using over-the-air (OTA), and the update program is rewritten on the vehicle side.

### SUMMARY

A center device manages data to be written to a plurality of electronic control devices installed in a vehicle. The center device is configured to generate a package including update data to be distributed to the vehicle; and distribute the package to the vehicle. When an input of information on a master device to which a package is to be distributed is received, the center device identifies an ID corresponding to the master device with reference to a logic ID management registration section on a basis of the information, acquires logic corresponding to the ID from a logic management registration section, and generates a package on a basis of the logic.

### BRIEF DESCRIPTION OF DRAWINGS

Objects, features and advantages of the present disclosure will become more apparent from the following detailed description made with reference to the accompanying drawings. In the drawings:

FIG. 1 is a functional block diagram illustrating a configuration of a package generation system mainly including a center device according to an embodiment;

FIG. 2 is a functional block diagram illustrating a configuration of a vehicle-side system;

FIG. 3 is a diagram illustrating a sequence of a preliminary preparation phase;

FIG. 4 is a diagram (part 1) illustrating an example of C-ECU information and logic IDs registered in a logic ID management DB;

FIG. 5 is a diagram (part 2) illustrating an example of the C-ECU information and the logic IDs registered in the logic ID management DB;

FIG. 6 is a diagram (part 3) illustrating an example of the C-ECU information and the logic IDs registered in the logic ID management DB;

FIG. 7 is a diagram illustrating an example of logic IDs and logic specifications registered in the logic management DB;

FIG. 8 is a flowchart illustrating contents of a determination process phase;

FIG. 9 is a diagram illustrating a list of data definitions;

FIG. 10 is a diagram illustrating a determination table for logic IDs with which sub target IDs are not associated;

FIG. 11 is a diagram illustrating a determination table for logic IDs with which sub target IDs are associated;

FIG. 12 is a diagram for explaining process contents of step S9;

FIG. 13 is a diagram illustrating process contents performed for each logic corresponding to a logic ID;

FIG. 14 is a diagram illustrating an overall process image of a package generation process;

FIG. 15A is a diagram (part 1) illustrating a package generation process corresponding to a CP-CP storage;

FIG. 15B is a diagram (part 2) illustrating the package generation process corresponding to the CP-CP storage;

FIG. 16A is a diagram (part 1) illustrating a package generation process corresponding to AP-AP streaming;

FIG. 16B is a diagram (part 2) illustrating the package generation process corresponding to the AP-AP streaming;

FIG. 17A is a diagram (part 1) illustrating a package generation process corresponding to CP-CP streaming;

FIG. 17B is a diagram (part 2) illustrating the package generation process corresponding to the CP-CP streaming;

FIG. 18A is a diagram (part 1) illustrating a package generation process corresponding to the CP-CP storage and CP-CP streaming;

FIG. 18B is a diagram (part 2) illustrating the package generation process corresponding to the CP-CP storage and CP-CP streaming;

FIG. 19A is a diagram (part 1) illustrating a package generation process corresponding to an AP-CP storage;

FIG. 19B is a diagram (part 2) illustrating the package generation process corresponding to the AP-CP storage;

FIG. 20A is a diagram (part 1) illustrating a package generation process corresponding to AP-CP streaming;

FIG. 20B is a diagram (part 2) illustrating the package generation process corresponding to the AP-CP streaming;

FIG. 21A is a diagram (part 1) illustrating a package generation process corresponding to the AP-CP storage and AP-AP streaming; and

FIG. 21B is a diagram (part 2) illustrating the package generation process corresponding to the AP-CP storage and AP-AP streaming.

### DETAILED DESCRIPTION

In recent years, with diversification of vehicle control such as a driving support function and an automated driving function, the scale of application programs for vehicle control, diagnosis, and the like installed in electronic control devices (hereinafter referred to as electronic control units (ECUs)) of vehicles is increasing. In addition, with the version upgrades due to functional improvements or the like, there are increasing opportunities to rewrite application programs of ECUs, so-called reprogramming. On the other hand, with the development of communication networks and the like, connected car technology has also become widespread.

When the update program is distributed using OTA, it is necessary to generate a data package for distribution. On the other hand, the vehicle-side system includes, for example, a data communication module (DCM) that directly communicates with a center device, a so-called target ECU that is an electronic control device to rewrite an update program, a central ECU that is a master device for transferring an update program received via the DCM to the target ECU, and the like. When the update program is transferred to the target ECU, the master device reads a file accompanying or related to the update program and identifies the target ECU as a transfer destination and the transfer method. That is, the file accompanying or related to the update program needs to be readable by the master device. Thus, the specifications of the package depend on the specifications of the central ECU, necessitating the generation of the distribution package according to the specifications of the central ECU.

However, conventionally, a specific process for generating the distribution package according to the specifications of the central ECU has not been disclosed.

The present disclosure provides a center device capable of generating a distribution package according to specifications of a master device, and a method for generating a distribution package.

According to one aspect of the present disclosure, a center device that manages data to be written to a plurality of electronic control devices installed in a vehicle is provided. The center device includes a package generation section that is configured to generate a package including update data to be distributed to the vehicle, and a package distribution section that is configured to distribute the package to the vehicle. The package generation section includes a logic management registration section that registers logic generating the package when the logic is generated according to a specification change of a master device that receives a package distributed from the center device and transfers update data to the electronic control device, and a logic identification (ID) management registration section that registers an ID assigned to the logic and a version of software of the master device corresponding to the logic when the ID and the version are notified. When an input of information on a master device to which a package is to be distributed is received from the package distribution section, the package generation section identifies an ID corresponding to the master device with reference to the logic ID management registration section on a basis of the information, acquires logic corresponding to the ID from the logic management registration section, and generates a package on a basis of the logic.

According to one aspect of the present disclosure, a center device that manages data to be written to a plurality of electronic control devices installed in a vehicle is provided. The center device includes a package generation section that is configured to generate a package including update data to be distributed to the vehicle, and a package distribution section that is configured to distribute the package to the vehicle. The package generation section includes a logic management registration section that manages logic generating the package and an ID assigned to the logic, and a logic ID management registration section that manages a version of software of a master device and an ID assigned to the logic for the version of the software. When an input of a version of software of a master device to which a package is to be distributed is received as information from the package distribution section, the package generation section identifies an ID corresponding to the master device with reference to the logic ID management registration section on a basis of the information, acquires logic corresponding to the ID from the logic management registration section, and generates a package on a basis of the logic.

According to the configuration, in the center device, the logic corresponding to the master device to which a specification change has been notified and the identification (ID) thereof are managed. Therefore, when information on the master device to which the package is to be distributed is input, the ID corresponding to the master device can be identified on the basis of the information, and the logic corresponding to the ID can be acquired to generate the package.

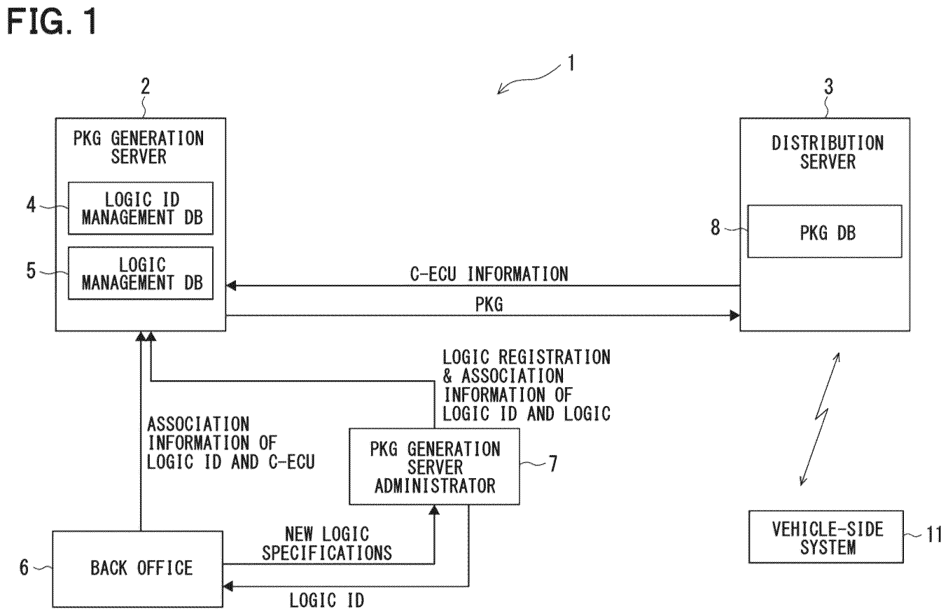

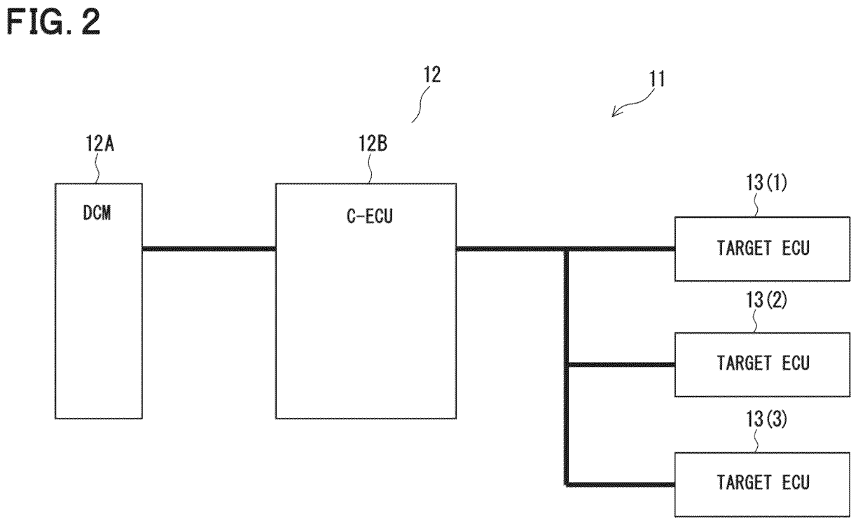

Hereinafter, an embodiment will be described. As illustrated in FIG. 2, a vehicle-side system 11 includes an OTA master 12 and a target ECU 13. The OTA master 12 includes a data communication module (DCM) 12A and a central ECU 12B. The DCM 12A directly communicates with a center device 1 illustrated in FIG. 1. When acquiring a distribution package received from the center device 1, the OTA master 12 transfers update data included in the acquired distribution package to each target ECU 13. Hereinafter, the “central ECU” is referred to as a “C-ECU”. The C-ECU 12B corresponds to a master device, and the target ECU 13 corresponds to an electronic control device.

As illustrated in FIG. 1, the center device 1 of the present embodiment includes a PKG generation server 2 and a distribution server 3. The PKG generation server 2 includes a logic ID management DB 4 and a logic management DB 5. “PKG” means “package” and “DB” means a database. The PKG generation server 2 corresponds to a package generation section, and the distribution server 3 corresponds to a package distribution section.

The PKG generation server 2 generates a data package to be distributed to the vehicle-side system 11, and the generated distribution package is distributed to the vehicle-side system 11 via the distribution server 3. The format of the distribution package varies depending on the specifications of the C-ECU 12B of each vehicle-side system 11. In the present embodiment, information for generating a distribution package corresponding to the specifications of the C-ECU 12B is referred to as “logic”. The distribution server 3 holds information on the C-ECU 12B to which the update data is to be transmitted in the database.

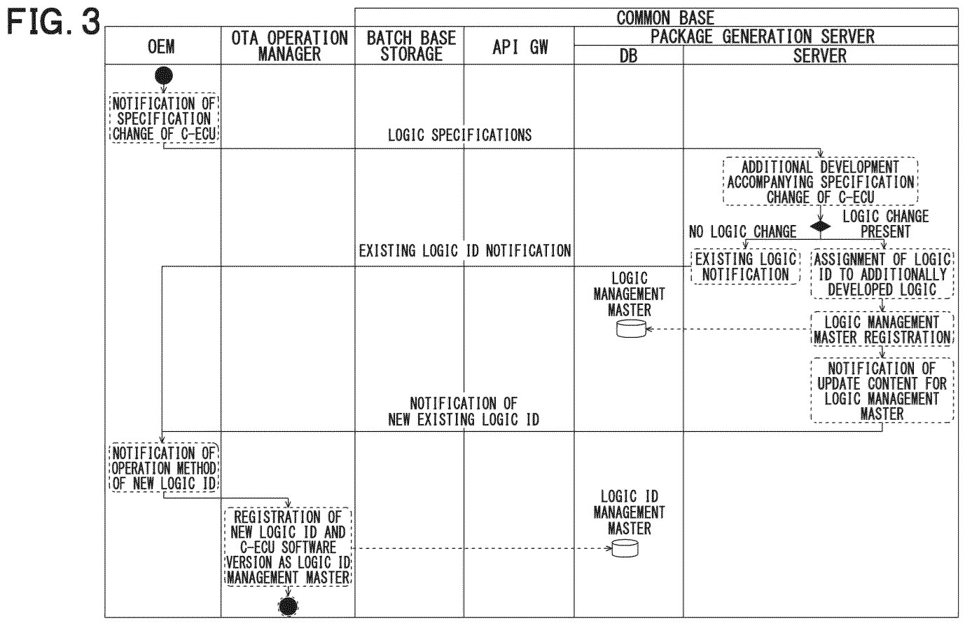

As also illustrated in FIG. 3, in a preliminary preparation phase, when the information related to a specification change of the C-ECU 12B is provided from a back office 6 of an original equipment manufacturer (OEM), an administrator 7 of the PKG generation server 2 generates a logic corresponding to the specifications using a tool and registers the logic in the logic management DB 5. In addition, an ID, which is an identifier, is attached to the generated logic and is notified to the back office 6. The ID is an example of a logic identifier. When being notified of the ID of the logic, the back office 6 notifies the center device 1 of the software version of the C-ECU 12B on which a specification change corresponding to the ID has been made. The notified information is registered in the logic ID management DB 4. In the figure, a logic management master corresponds to the logic management DB 5, and a logic ID management master corresponds to the logic ID management DB 4.

Thereafter, when the information on the C-ECU 12B to which the update data is to be transmitted is input from the distribution server 3, the PKG generation server 2 acquires a logic ID corresponding to the C-ECU 12B from the logic ID management DB 4 on the basis of the information on the C-ECU 12B. When the logic corresponding to the acquired logic ID is acquired from the logic management DB 5, a package is generated according to the logic. The generated package is registered in a package DB 8 and distributed to the C-ECU 12B as the transmission target via the distribution server 3.

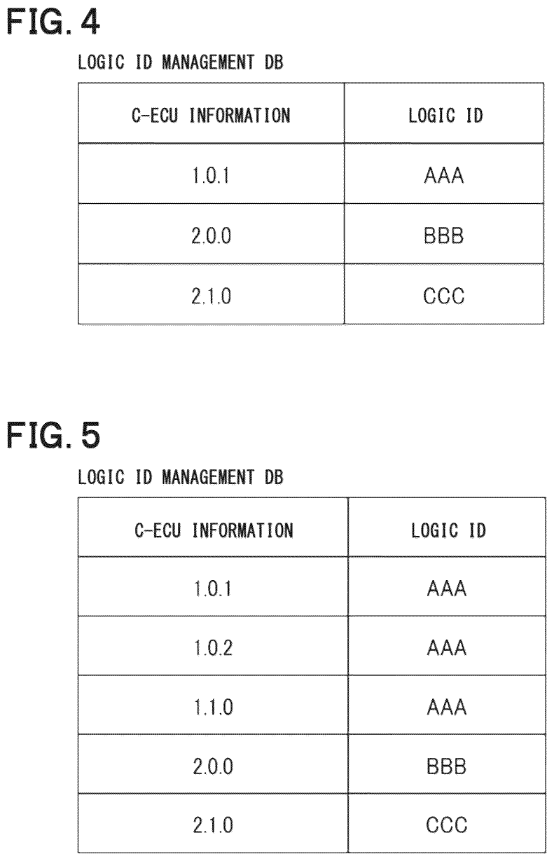

As illustrated in an example in FIG. 4, in the logic ID management DB 4, the software version or the software ID of each C-ECU 12B is set as C-ECU information, and the logic ID corresponding to the C-ECU information is registered. In FIG. 5, two pieces of C-ECU information “1.0.2” and “1.1.0”, each having a logic ID of “AAA”, are added from the state illustrated in FIG. 4.

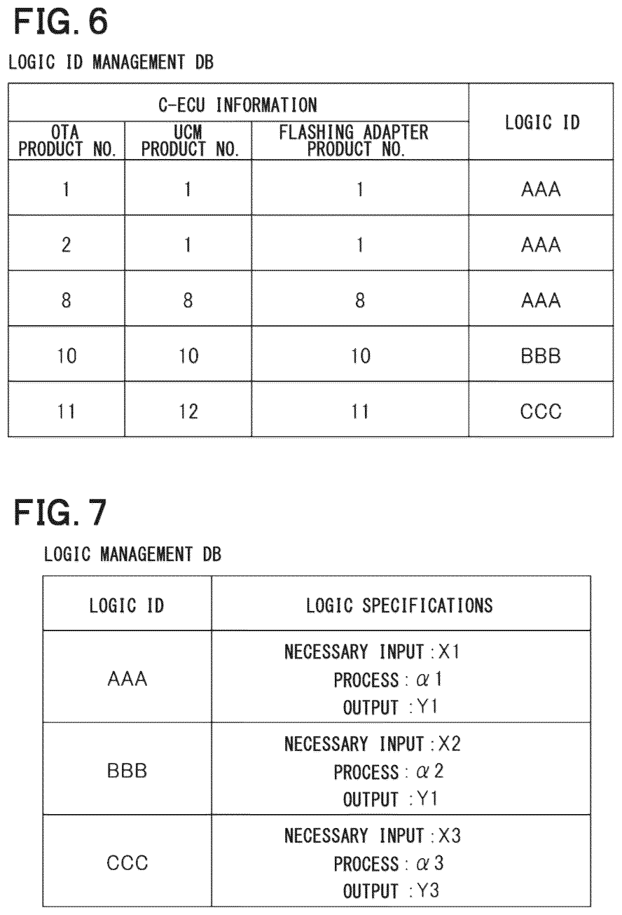

In another example illustrated in FIG. 6, the C-ECU information is a combination of a plurality of product numbers. For example, the plurality of product numbers are an OTA product number, an update configuration management (UCM) product number, a flashing adaptor product number, and the like. The UCM and the flashing adaptor are described in the specifications of the AUTomotive Open System ARchitecture (AUTOSAR) standardization organization, and the like, and hence the details thereof are omitted.

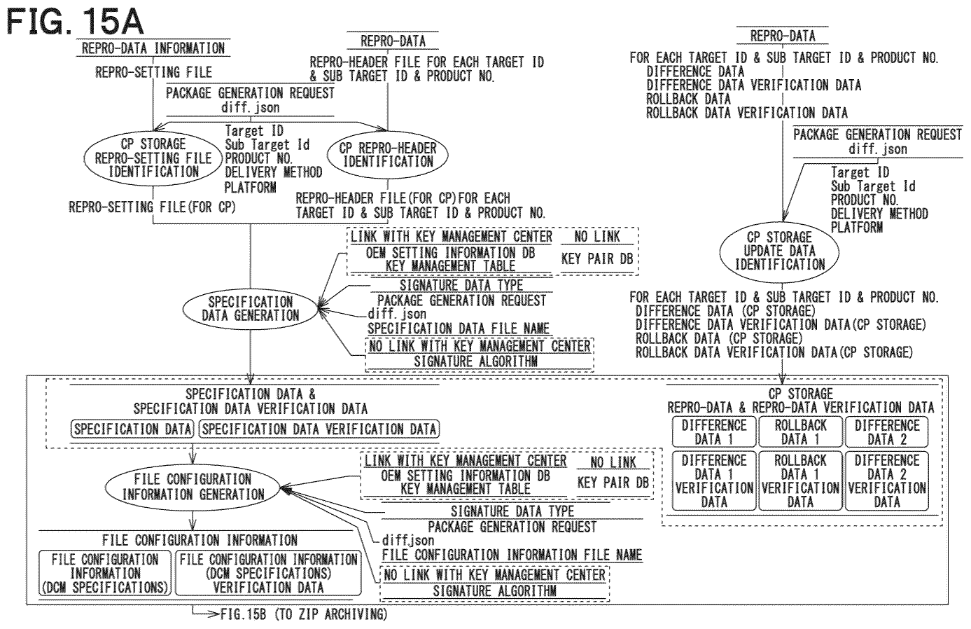

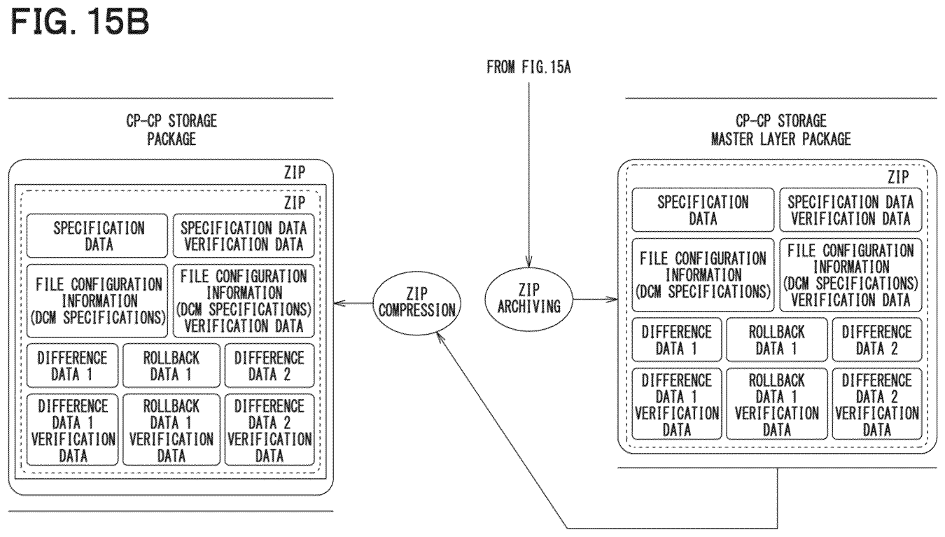

As illustrated in FIG. 7, specifications of a logic corresponding to the logic ID are registered in the logic management DB 5. The logic specifications define inputs, processes, and outputs necessary to generate the data package. FIGS. 15 to 21 illustrate the logic specifications.

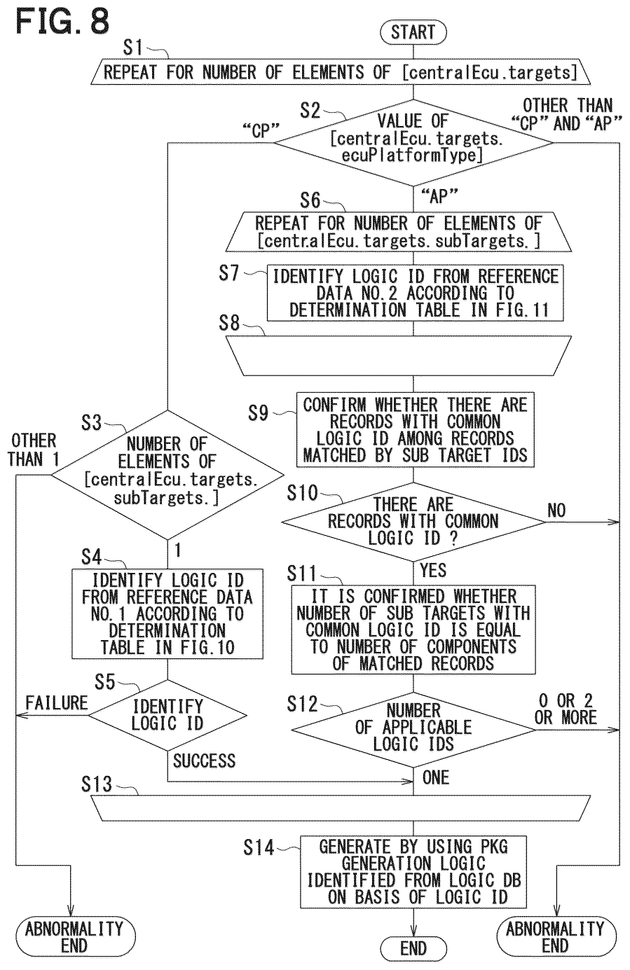

In a determination process phase illustrated in FIG. 8, preprocessing to generate packages for the number of elements of the C-ECU 12B and the target ECU 13 is performed in a loop of S1 to S14. First, the platform type of the C-ECU 12B is determined to be one of three types of AP, CP, and others (S2). In the case of “others”, abnormality termination occurs.

Here, AP and CP each represent a software platform. The software platform is also referred to as a software architecture. CP represents an AUTOSAR Classic Platform, and AP represents an AUTOSAR Adaptive Platform. Moreover, an ECU that operates conforming to the CP specifications may be referred to as a CP ECU or a CP's ECU, and an ECU that operates conforming to the AP specifications may be referred to as an AP ECU or an AP's ECU.

In AP and CP, an operating system used, a so-called OS, and a development language differ. The CP ECU and the AP ECU differ in the structure of the packages each can receive. The difference in package structure is mainly caused by a difference in the processing performance of the ECU. The processing performance of a CP's ECU is generally low, so that specification data and the like included in the package are also described as binary data. This makes the package data structure easy to interpret and process, even for the ECU with low processing performance. The specification data is data that defines information related to rewriting of an application program.

On the other hand, since a processor with high processing performance is used for an AP's ECU, it is possible to install a parser function to analyze structural character data described in some language and convert the data into a data structure that can be handled by a program. The data structure can adopt an object-oriented data format such as JavaScript Object Notation (JSON) instead of simple binary data, resulting in a flexible package data structure.

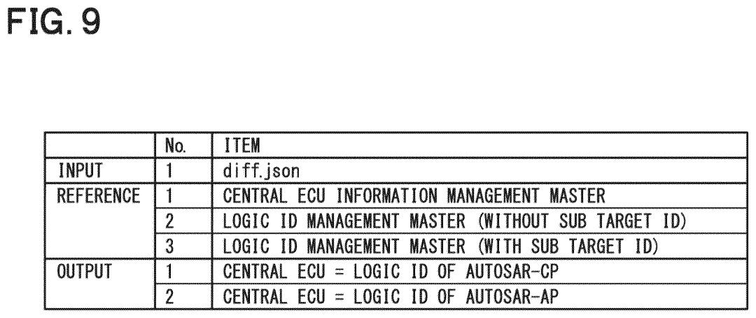

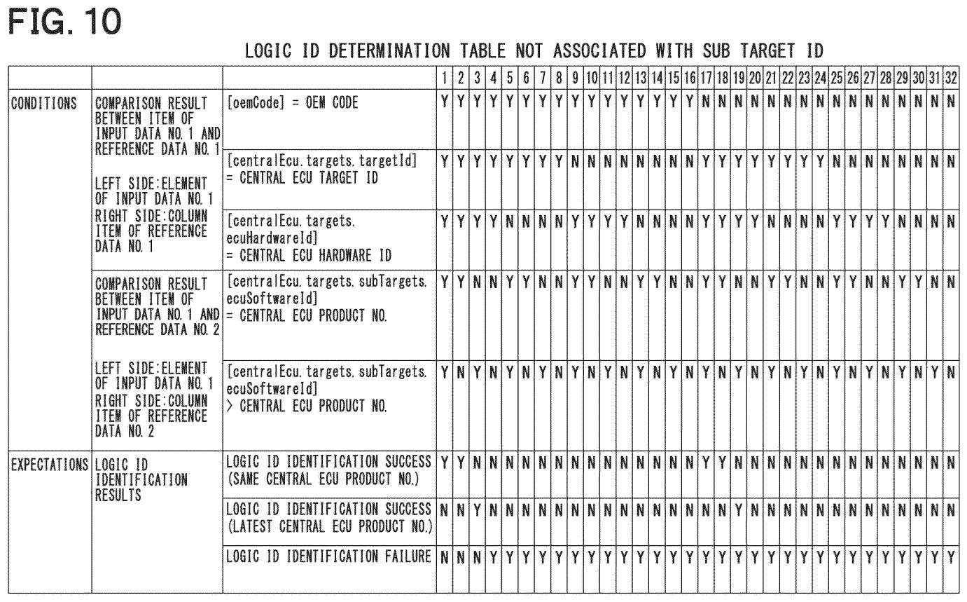

When the type of the C-ECU 12B is CP, it is confirmed that the number of elements is “1” (S3), and thereafter, a logic ID is identified from reference data No. 1 and reference data No. 2 illustrated in FIG. 9 according to a determination table illustrated in FIG. 10 (S4). In the figure, “Y” represents “YES”, and “N” represents “NO”. When the logic ID is successfully identified in subsequent step S5, the process returns to step S1.

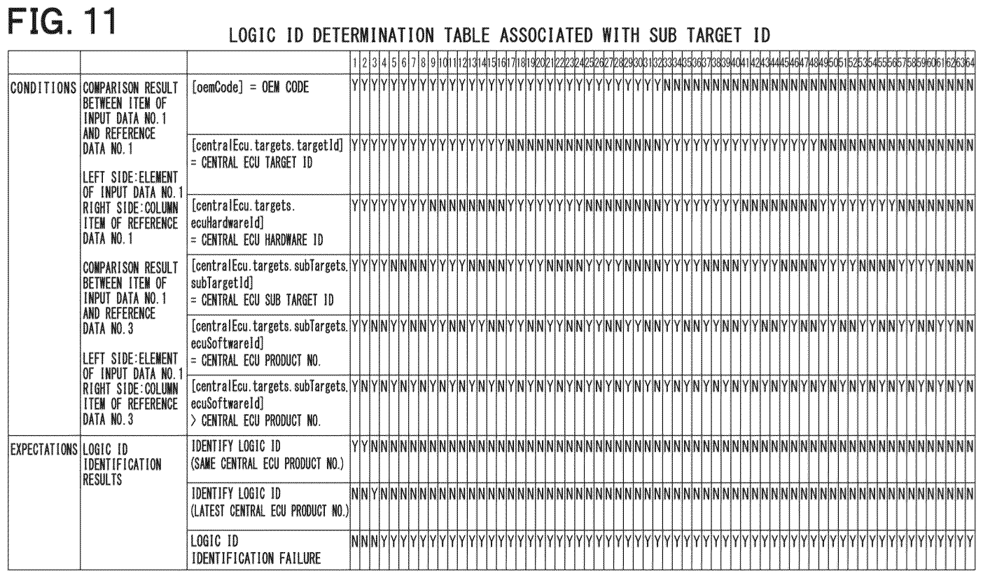

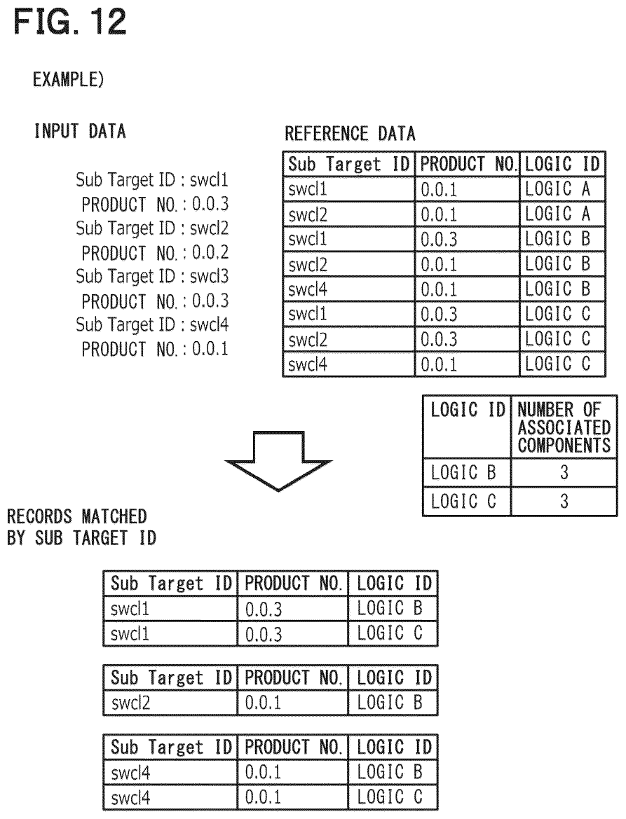

When the type of the C-ECU 12B is AP, the loop of steps S6 to S8 is repeated for the number of elements of each ECU, and a logic ID is identified from the reference data No. 1 and reference data No. 3 illustrated in FIG. 9 according to the determination table illustrated in FIG. 11 (S7). After the process exists from the loop, as illustrated in FIG. 12, it is confirmed whether there are records with a common logic ID among records matched by sub target IDs (S9). When there are records with the common logic ID (S10; Yes), it is confirmed whether the number of sub target IDs with the common logic ID is equal to the number of components of the matched records (S11). In the example illustrated in FIG. 12, for example, the number of sub target IDs with the logic ID B is “3”. When the number of applicable logic IDs is one, the process returns to step S1, and when the number of applicable logic IDs is 0 or 2 or more, abnormality termination occurs. After the process exists from the loop of steps S1 to S13, a data package is generated using a logic identified from the logic management DB 5 on the basis of each logic ID (S14).

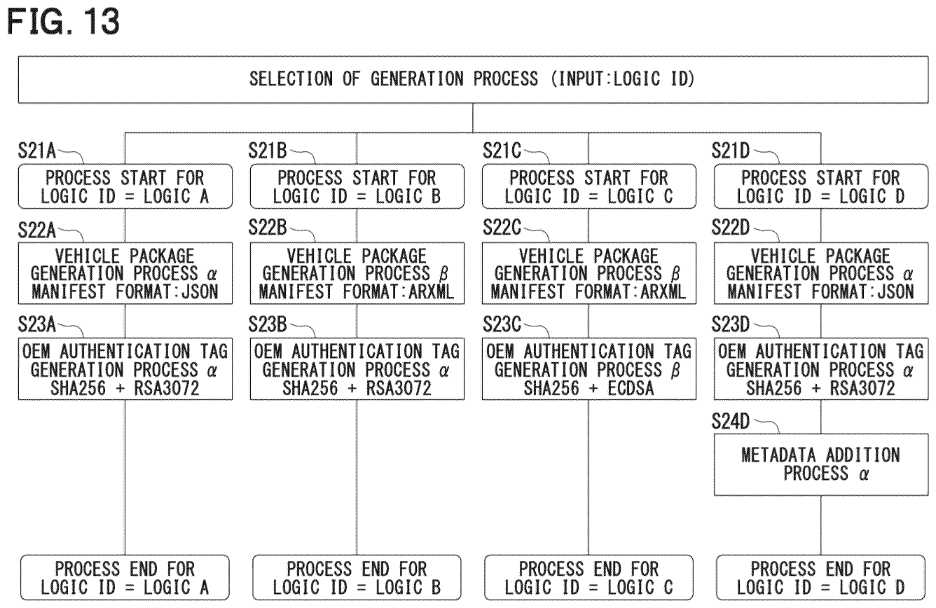

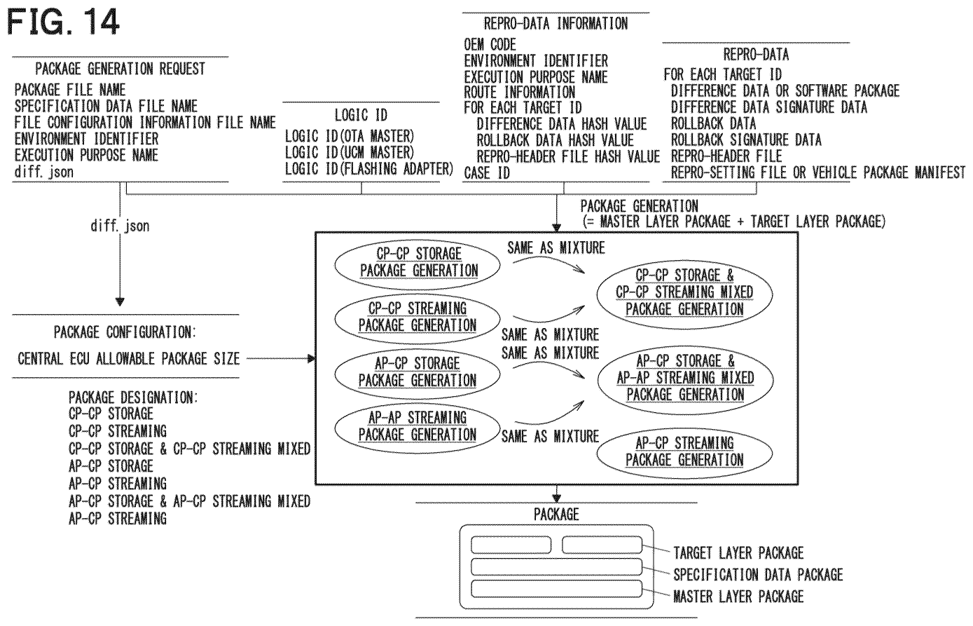

As illustrated in FIG. 13, when the logic ID is input, the PKG server 2 starts processes corresponding to the respective logics according to, for example, ID=A to D (S21A to S21D). In subsequent steps S22A to S22D, a vehicle package generation process is performed. The vehicle package includes a manifest of each software package and a vehicle package manifest. The manifest includes information such as a diagnostic address and an ID of a UCM to which the package is to be distributed. FIGS. 14 to 21 illustrate processes after the generation process has been selected.

The vehicle package manifest includes information necessary for the control and distribution of the campaign delivered to the vehicle as a notification that data update is prepared, for example, information such as dependency, target vehicle, safety policy, and driver notification setting. When a UCM master, which is a software module installed in the C-ECU 12B, understands the update content for the data by interpreting the vehicle package, the UCM master controls which software package is transferred to which UCM and in what order. The UCM interprets the software package passed from the UCM master and executes an installation process on the target ECU 13. The UCM master and the UCM are described in the specifications of AUTOSAR and other documents, and hence the details thereof are omitted. The UCM master of the embodiment may be a reprogramming master application conforming to the UCM master of AUTOSAR, and the UCM of the embodiment may be a reprogramming application conforming to the UCM of AUTOSAR.

In subsequent steps S23A to S23D, an OEM Authentication Tag to be added to the vehicle package is generated, and a hash function SHA256 for generating a hash value is applied and an encryption method is selected. In step S24D in the logic ID=D, a metadata addition process is performed. The metadata includes the configuration information of the distribution package, in other words, information indicating the configuration type of the package, and control information for acquiring data. The content is defined to prevent an error in the distribution of the package by checking the metadata content on the vehicle side and to enable the OTA master 12 to know information for downloading update data for each of the plurality of target ECUs 13.

FIG. 14 schematically illustrates a package generation process. “Repro” means “reprogramming”. There are data update methods of the following types: a storage method in which all update programs are downloaded from the center device 1 to a memory on the vehicle side before the update is performed; and a streaming method in which the update is performed while the update program is being downloaded from the center device 1 to the vehicle side. The package generation process is divided into seven cases depending on the combination of the platform types the C-ECU 12B and the target ECU 13, and the storage and streaming methods.

### <CP-CP Storage>

As illustrated in FIG. 15A and FIG. 15B, by identifying the logic for generating the package, the corresponding CP storage repro-setting file, CP repro-header, and CP storage update data are acquired. Specification data is generated from the repro-setting file and the repro-header, and verification data is added to the specification data. For the update data, difference data from the data before the update and rollback data are generated, and verification data for each of those pieces of data is added. After the file configuration information is generated and its verification data is added, the file configuration information and the verification data are collectively archived to obtain a master layer package corresponding to the CP-CP storage. Finally, the package is compressed into a ZIP file.

### <AP-AP Streaming>

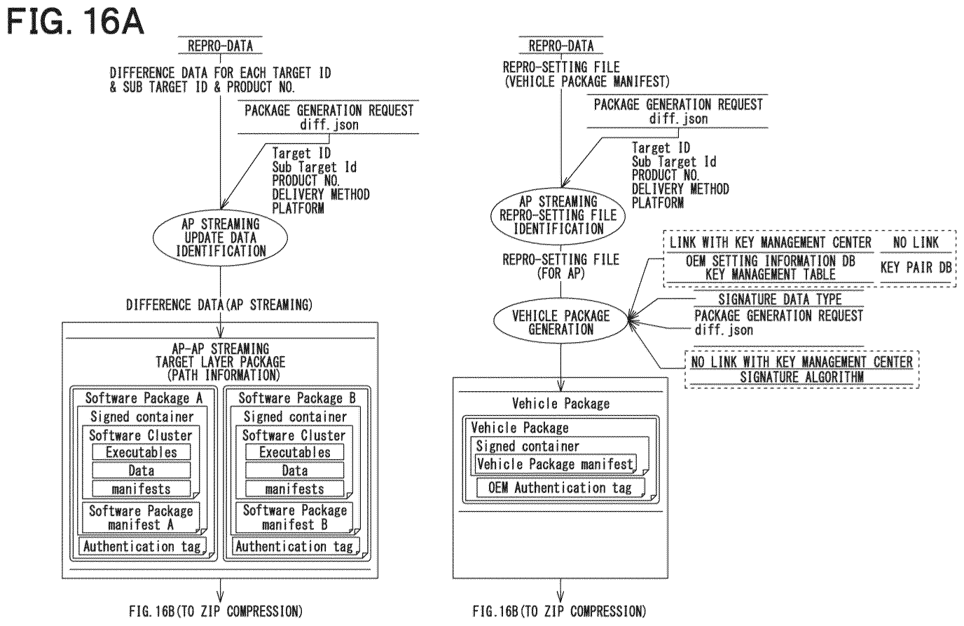

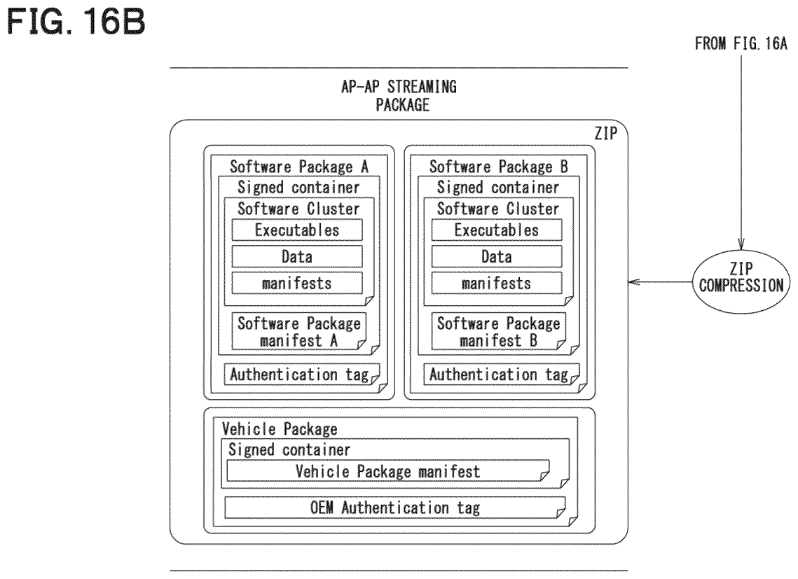

As illustrated in FIG. 16A and FIG. 16B, an AP streaming update data file and an AP streaming repro-setting file are identified according to the logic. For the update data, difference data is generated as described above, and an AP-AP streaming target layer package is generated. A vehicle package is generated from the repro-setting file for AP. These are collectively compressed into a ZIP file to form a final package.

### <CP-CP Streaming>

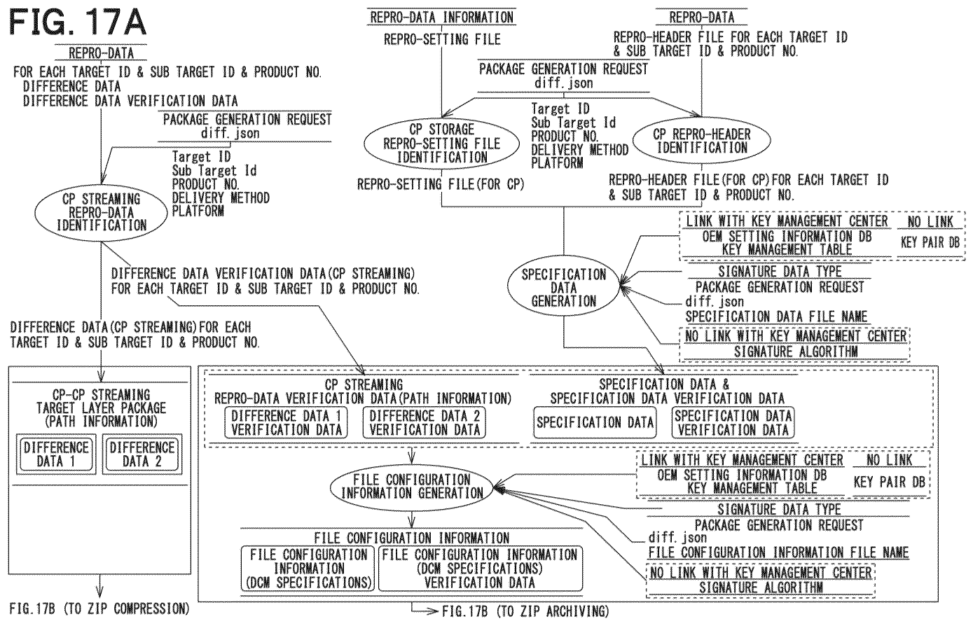

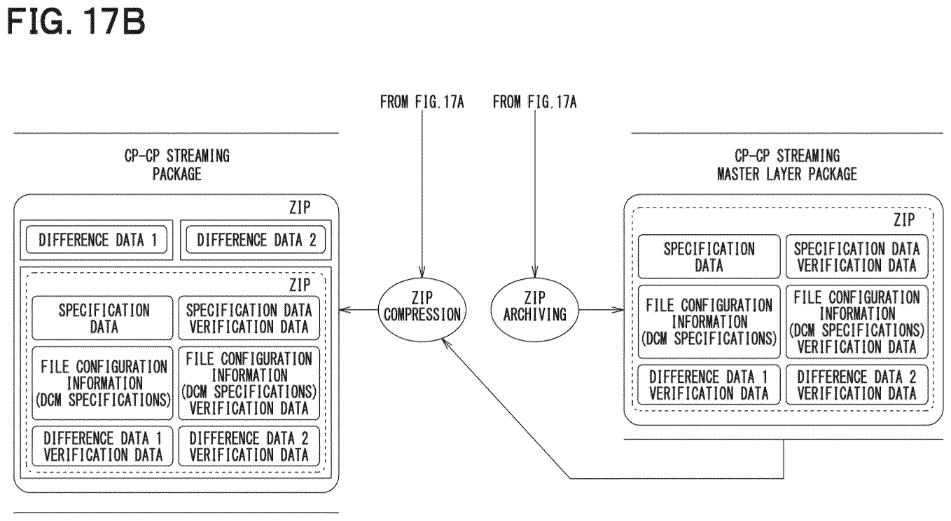

As illustrated in FIG. 17A and FIG. 17B, specification data and its verification data are generated similarly to the case of FIG. 15A and FIG. 15B. When the update data for the CP streaming is identified, a target layer package for the corresponding difference data and the verification data of the difference data are generated. These are collectively compressed into a ZIP file.

### <CP-CP Storage and CP-CP Streaming Mixed>

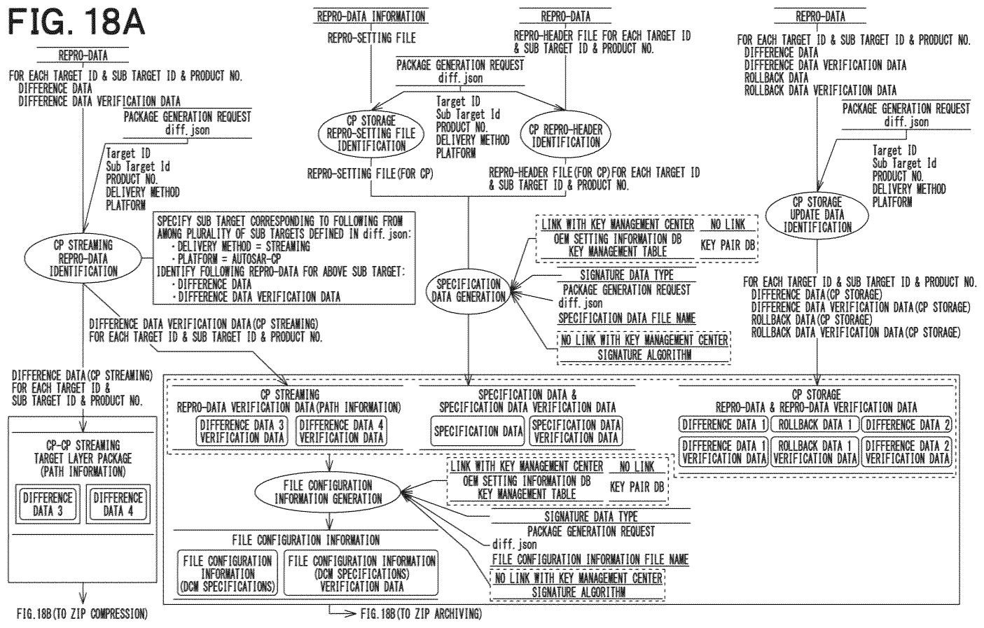

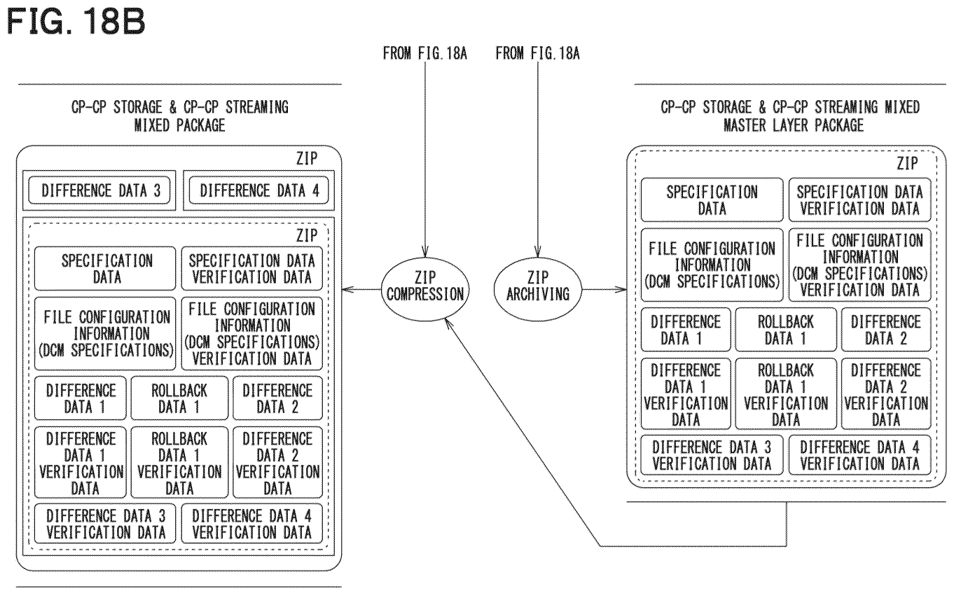

In this case, as illustrated in FIG. 18A and FIG. 18B, a pattern integrating FIGS. 15 and 17 is formed, combining the data for the CP-CP storage and the data for the CP-CP streaming into a single package.

### <AP-CP Storage>

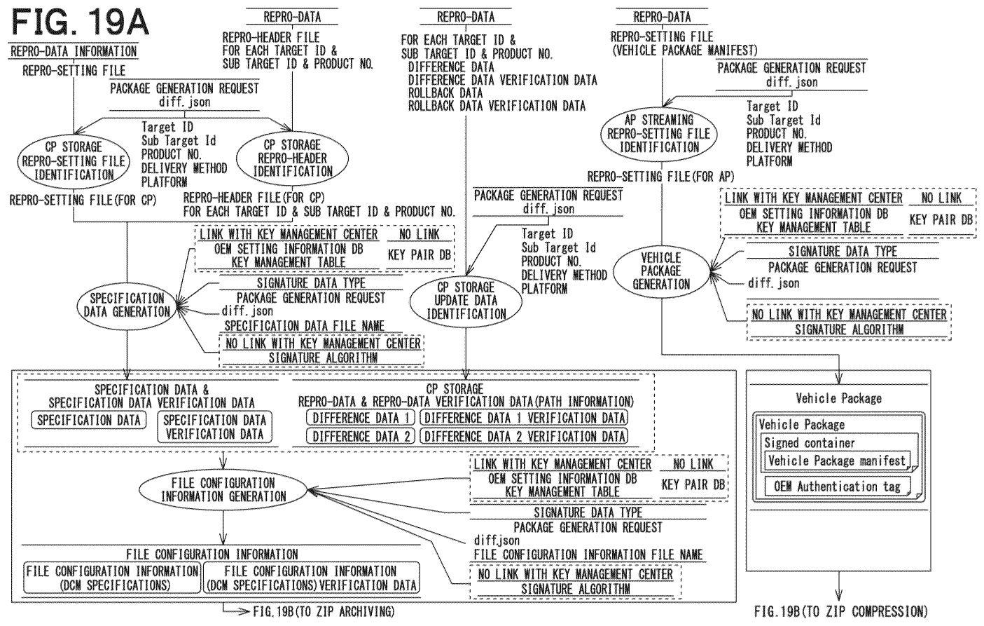

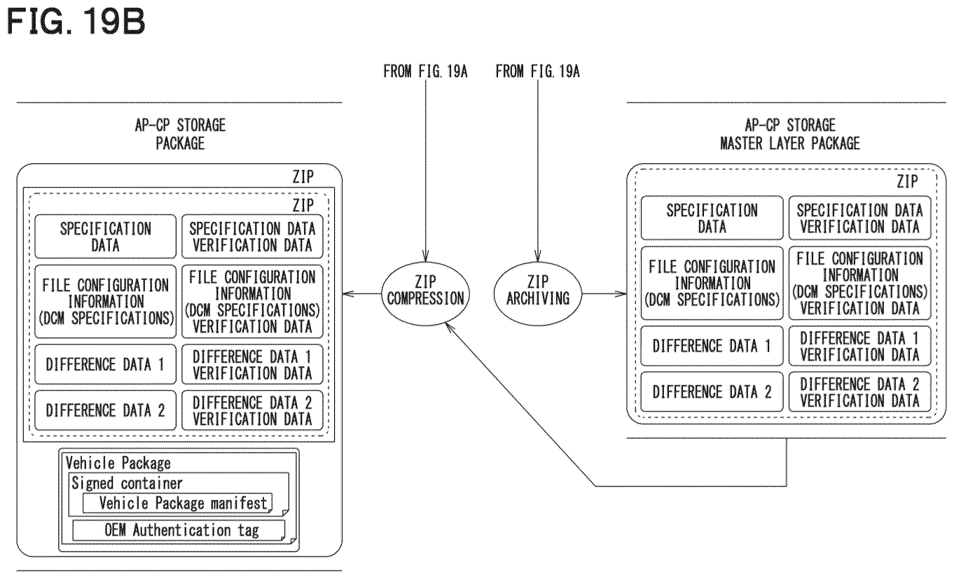

As illustrated in FIG. 19A and FIG. 19B, the process related to the CP storage portion is similar to that in FIG. 15A and FIG. 15B, but the repro-data and its verification data do not include rollback data. In the process related to the AP storage portion, only a vehicle package is generated similarly to FIG. 16A and FIG. 16B.

### <AP-CP Streaming>

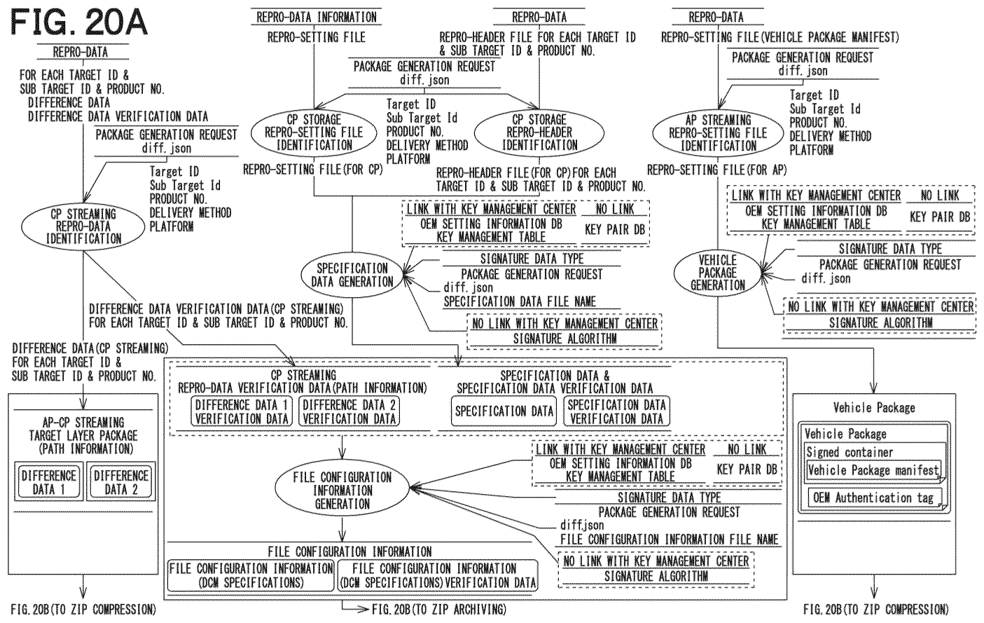

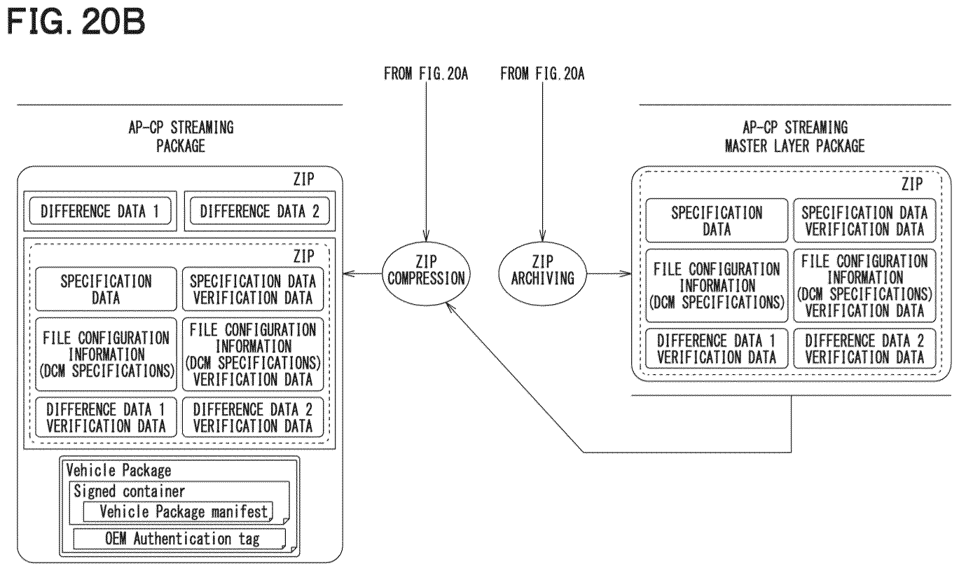

As illustrated in FIG. 20A and FIG. 20B, the generation of a vehicle package is added to the process illustrated in FIG. 17A and FIG. 17B.

### <AP-CP Storage and AP-AP Streaming Mixed>

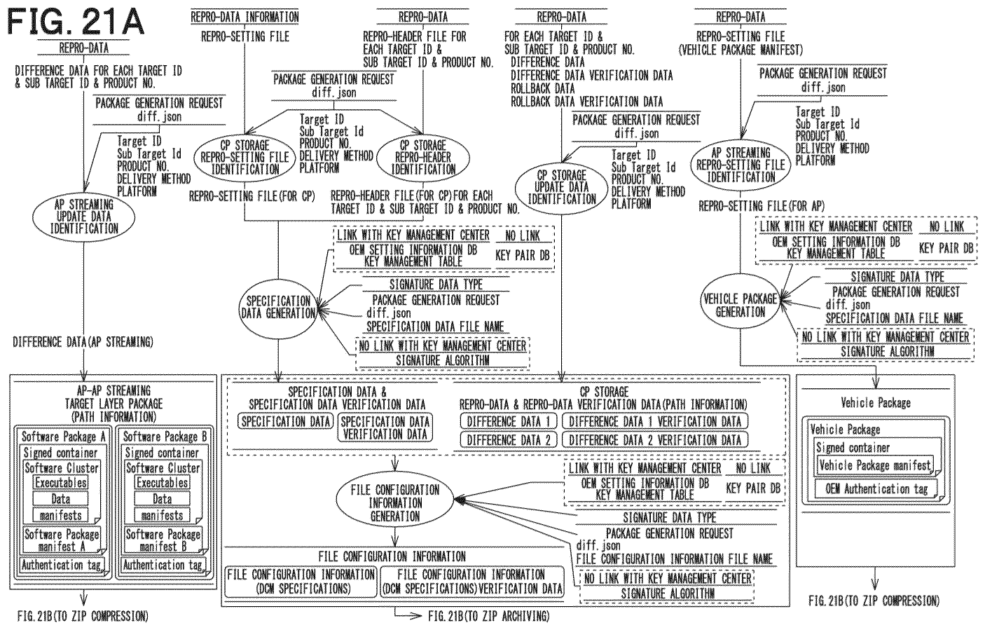

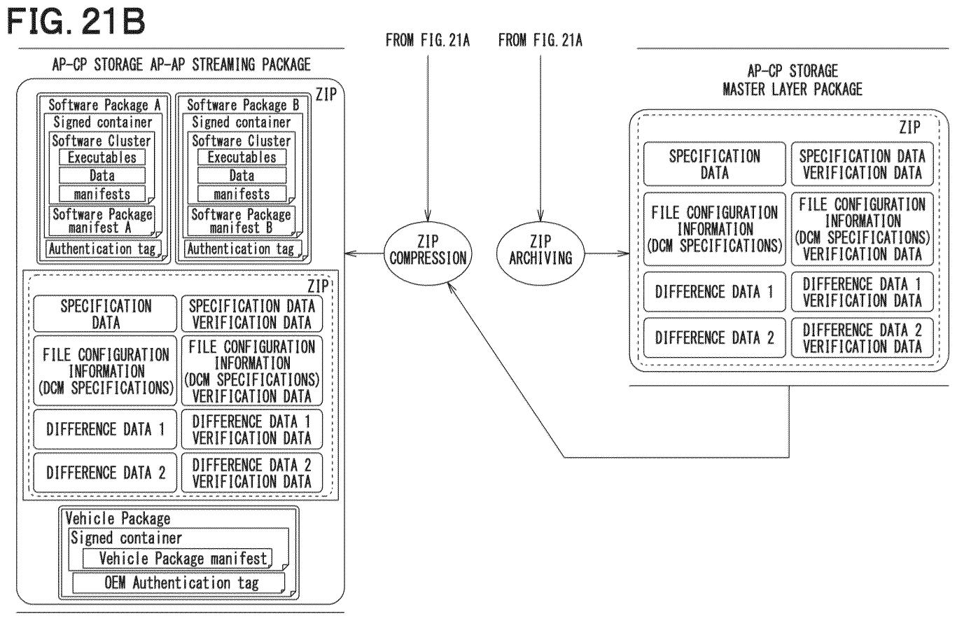

As illustrated in FIG. 21A and FIG. 21B, the process illustrated in FIG. 16A and FIG. 16B and the process illustrated in FIG. 19A and FIG. 19B are integrated.

As described above, according to the present embodiment, the center device 1 is equipped with the PKG generation server 2 that generates a package including update data to be distributed to the vehicle, and the distribution server 3 that distributes the generated package to the vehicle. When a specification change of the C-ECU 12B is notified from the OEM, the administrator 7 generates a logic for generating the package according to the specification change, registers the logic in the logic management DB 5, and notifies the OEM of the logic with its ID.

When the ID and the software version of the C-ECU 12B corresponding to the ID are notified from the OEM, the ID and the software version are registered in the logic ID management DB 4. When information on the C-ECU 12B to which the package is to be distributed is input from the distribution server 3, the PKG generation server 2 identifies an ID corresponding to the C-ECU 12B with reference to the logic ID management DB 4 on the basis of the information, acquires a logic corresponding to the ID from the logic management DB 5, and generates a package on the basis of the logic.

With such a configuration, in the center device 1, the logic corresponding to the C-ECU 12B that has been notified of the specification change from the OEM and the ID of the logic are managed. Therefore, when information on the C-ECU 12B to which the package is to be distributed is input, the corresponding ID can be identified on the basis of the information, and the logic corresponding to the ID can be acquired to generate a package.

### OTHER EMBODIMENTS

Although the present disclosure has been described in accordance with the examples, it is understood that the disclosure is not limited to such examples or structures. The present disclosure includes various modification examples and equivalents thereof. In addition, while the various combinations and configurations, which are preferred, other combinations and configurations, including more, less or only a single element, are also within the spirit and scope of the present disclosure.

Means and/or functions provided by each device or the like may be provided by software recorded in a tangible memory device and a computer that can execute the software, software only, hardware only, or some combination of them. For example, when the control device is provided by an electronic circuit that is hardware, it can be provided by a digital circuit including a large number of logic circuits, or an analog circuit.

The control unit and the method thereof of the present disclosure may be implemented by a dedicated computer provided by configuring a processor and a memory programmed to execute one or more functions embodied by a computer program. Alternatively, the control unit and the technique according to the present disclosure may be achieved by a dedicated computer provided by constituting a processor with one or more dedicated hardware logic circuits. Alternatively, the control unit and the technique according to the present disclosure may be achieved using one or more dedicated computers constituted by a combination of the processor and the memory programmed to execute one or more functions and the processor with one or more hardware logic circuits. The computer program may also be stored on a computer-readable and non-transitory tangible storage medium as an instruction executed by a computer.

What is claimed is:

1. A center device that manages data to be written to a plurality of electronic control devices installed in a vehicle, the center device comprising:
a package generation section that is configured to generate a package including update data to be distributed to the vehicle; and
a package distribution section that is configured to distribute the package to the vehicle,
wherein
the package generation section includes
a logic management registration section that registers logic generating the package when the logic is generated according to a specification change of a master device that receives a package distributed from the center device and transfers update data to the electronic control device, and
a logic identification (ID) management registration section that registers an ID assigned to the logic and a version of software of the master device corresponding to the logic when the ID and the version are notified, and
when an input of information on a master device to which a package is to be distributed is received from the package distribution section, the package generation section identifies an ID corresponding to the master device with reference to the logic ID management registration section on a basis of the information, acquires logic corresponding to the ID from the logic management registration section, and generates a package on a basis of the logic.

2. A center device that manages data to be written to a plurality of electronic control devices installed in a vehicle, the center device comprising:
a package generation section that is configured to generate a package including update data to be distributed to the vehicle; and
a package distribution section that is configured to distribute the package to the vehicle,
wherein
the package generation section includes
a logic management registration section that manages logic generating the package and an ID assigned to the logic, and
a logic ID management registration section that manages a version of software of a master device and an ID assigned to the logic for the version of the software, and
when an input of a version of software of a master device to which a package is to be distributed is received as information from the package distribution section, the package generation section identifies an ID corresponding to the master device with reference to the logic ID management registration section on a basis of the information, acquires logic corresponding to the ID from the logic management registration section, and generates a package on a basis of the logic.

3. A method for generating a distribution package, in which a package including update data to be distributed to a vehicle is generated to write data to a plurality of electronic control devices installed in the vehicle, the method comprising:
registering logic for generating the package in a logic management registration section when the logic is generated according to a specification change of a master device that receives a package distributed from a center device and transfers update data to the electronic control device;
registering an ID assigned to the logic and a version of software of the master device corresponding to the logic in a logic ID management registration section when the ID and the version are notified; and
identifying, when an input of information on a master device to which a package is to be distributed is received, an ID corresponding to the master device with reference to the logic ID management registration section on a basis of the information, acquiring logic corresponding to the ID from the logic management registration section, and generating a package on a basis of the logic.
